(19) United States
(12) Patent Application Publication
(10) Pub. No.: US 2009/0275005 A1
(43) Pub. Date: Nov. 5, 2009

(54) Methods, Systems, and Computer Program Products for Speech Assessment

(76) Inventor: Katarina L. Haley, Hillsorough, NC (US)

Correspondence Address: JENKINS, WILSON, TAYLOR & HUNT, P. A., Suite 1200 UNIVERSITY TOWER, 3100 TOWER BLVD.,, DURHAM, NC, 27707, US

(21) Appl. No.: 12/085,239

(22) PCT Filed: Nov. 16, 2006
(86) PCT No.: PCT/US06/44504

§ 371 Date: Feb. 11, 2009

Related U.S. Application Data
(60) Provisional application No. 60/738,397, filed on Nov. 18, 2005.

(51) Int. Cl. G09B 5/00; G09B 19/04

(52) U.S. Cl. 434/169; 434/185

(57) ABSTRACT

Methods, Systems, And Computer Program Products For Speech Assessment are disclosed. According to an embodiment, a speech assessment method can be provided and include prompting a speaker to pronounce one or more words. The one or more words pronounced by the speaker can be recorded to generate one or more recorded pronunciations. The one or more recorded pronunciations can be presented to a listener. A listener can be prompted to enter a phonetic or orthographic representation of the one or more recorded pronunciations in response to presentation of the one or more recorded pronunciations. Further, the phonetic or orthographic representation entered can be automatically compared with a correct spelling of the one or more words.

### RELATED APPLICATIONS

This application claims the benefit of U.S. Patent Application Ser. No. 60/738,397, filed Nov. 18, 2005, the disclosure of which is incorporated herein by reference in its entirety.

### GOVERNMENT INTEREST

This invention was made with U.S. Government support from the National Institutes of Health Grant No. NIDCD R03 DC006163-02. The U.S. Government has certain rights in the invention.

### TECHNICAL FIELD

The subject matter disclosed herein relates generally to speech. More particularly, the subject matter disclosed herein relates to methods, systems, and computer program products for speech assessment.

### BACKGROUND

Articulation and phonology disorders are among the most common speech and language disorders. Apraxia of speech is a speech disorder in which a person has difficulty saying what he or she wants to say correctly and consistently. Aphasia is a language disorder that can result from damage to portions of the brain that are responsible for language. To diagnose apraxia of speech and aphasia, a speech-language pathologist or clinician may ask a person to perform speech tasks such as pronouncing a particular word several times or repeating a list of words. Based on the person's pronunciations, the speech-language pathologist may be able to diagnose the person's speech disorder and its severity.

In order to prompt a person to pronounce words for speech assessment, a speech-language pathologist will typically use cards containing a word or graphical image representative of the word. The speaker can be asked to pronounce the words associated with the cards as the cards are presented one-by-one to the speaker. Based on the speaker's pronunciations, the speech-language pathologist can assess the speech of the speaker. One problem with using cards for speech assessment is that the cards can be difficult to handle and maintain in a proper sequence. In addition, it may be difficult for the pathologist to record pronunciation data as the cards are being presented.

Computer-based systems have been developed for use in analyzing speech disorders. These systems typically include a database for storing word records for use in assessing speech. The records can contain a word and an image associated with the word. The words and images in the database can be presented sequentially to prompt a speaker to pronounce the words. The speaker's pronunciations can then be analyzed by a pathologist. Difficulties remain though in effectively and conveniently prompting a speaker to pronounce a series of words, recording the pronunciations of the words, and analyzing the recorded pronunciations.

In view of the shortcomings of existing speech assessment techniques, there exists a need for improved methods, systems, and computer program products for speech assessment.

### SUMMARY

According to one aspect, the subject matter described herein includes a speech assessment method. The method can include prompting a speaker to pronounce one or more words. The one or more words pronounced by the speaker can be recorded to generate one or more recorded pronunciations. The one or more recorded pronunciations can be presented to a listener. A listener can be prompted to enter a phonetic or orthographic representation of the one or more recorded pronunciations in response to presentation of the one or more recorded pronunciations. Further, the entered phonetic or orthographic representation can be automatically compared with a correct spelling of the one or more words.

The subject matter described herein can be implemented as a computer program product comprising computer executable instructions embodied in a computer readable medium. Exemplary computer readable media suitable for implementing the subject matter described herein can include disk memory devices, chip memory devices, application specific integrated circuits, programmable logic devices, downloadable electrical signals, and/or any other suitable computer readable media. In addition, a computer program product that implements the subject matter described herein may be located on a single device or computing platform. Alternatively, the subject matter described herein can be implemented on a computer program product that is distributed across multiple devices or computing platforms.

### BRIEF DESCRIPTION OF THE DRAWINGS

Exemplary embodiments of the subject matter will now be explained with reference to the accompanying drawings, of which:

FIG. 1 is a block diagram of a computer system for speech assessment according to an embodiment of the subject matter described herein;

FIG. 2 is a flow chart of an exemplary process for configuring the computer system shown in FIG. 1 for a speech assessment session according to an embodiment of the subject matter described herein;

FIGS. 3A and 3B are flow charts of an exemplary process for assessing speech using the computer system shown in FIG. 1 according to an embodiment of the subject matter described herein;

FIG. 4 is a flow chart of another exemplary process for assessing speech using the computer system shown in FIG. 1 according to an embodiment of the subject matter described herein;

FIGS. 5A, 5B, and 5C are flow charts of an exemplary process for assessing speech using an orthographic transcription format according to the subject matter described herein;

FIG. 6 is an exemplary screen display that can be displayed by the computer system shown in FIG. 1 for initiating a speech assessment session according to an embodiment of the subject matter described herein;

FIG. 7 is another exemplary screen display that can be displayed by the computer system shown in FIG. 1 for initiating a speech assessment session according to an embodiment of the subject matter described herein;

FIG. 8 is an exemplary screen display that can be displayed by the computer system shown in FIG. 1 for configuring a session template according to an embodiment of the subject matter described herein;

FIGS. 9A-9E are exemplary screen displays that can be displayed by the computer system shown in FIG. 1 for configuring speech assessment reports according to an embodiment of the subject matter described herein;

FIG. 10 is an exemplary screen display that can be displayed by the computer system shown in FIG. 1 for providing recording information according to an embodiment of the subject matter described herein;

FIG. 11 is an exemplary screen display that can be displayed by the computer system shown in FIG. 1 for providing intelligibility test information according to an embodiment of the subject matter described herein;

FIG. 12 is an exemplary screen display that can be displayed by the computer system shown in FIG. 1 for phonetic transcription according to an embodiment of the subject matter described herein;

FIG. 13 is an exemplary screen display that can be displayed by the computer system shown in FIG. 1 for restart and revision coding according to an embodiment of the subject matter described herein;

FIG. 14 is an exemplary screen display that can be displayed by the computer system shown in FIG. 1 for measuring and editing a recorded pronunciation according to an embodiment of the subject matter described herein;

FIG. 15 is an exemplary screen display that can be displayed by the computer system shown in FIG. 1 for displaying and configuring word list information according to an embodiment of the subject matter described herein; and

FIG. 16 is an exemplary screen display that can be displayed by the computer system shown in FIG. 1 for displaying miscellaneous clinical test and diagnosis information according to an embodiment of the subject matter described herein.

### DETAILED DESCRIPTION

The subject matter described herein can provide for the elicitation, recording, and storage of word pronunciations provided by persons for speech assessment, such as for persons that may have a speech or language disorder. Further, the subject matter described herein can provide for the measurement and perceptual testing of the speech features in the word pronunciations that may be relevant to the assessment of speech production difficulties. According to one aspect, a speech assessment system of the subject matter described herein may be implemented as hardware, software, and/or firmware components executing on a computer.

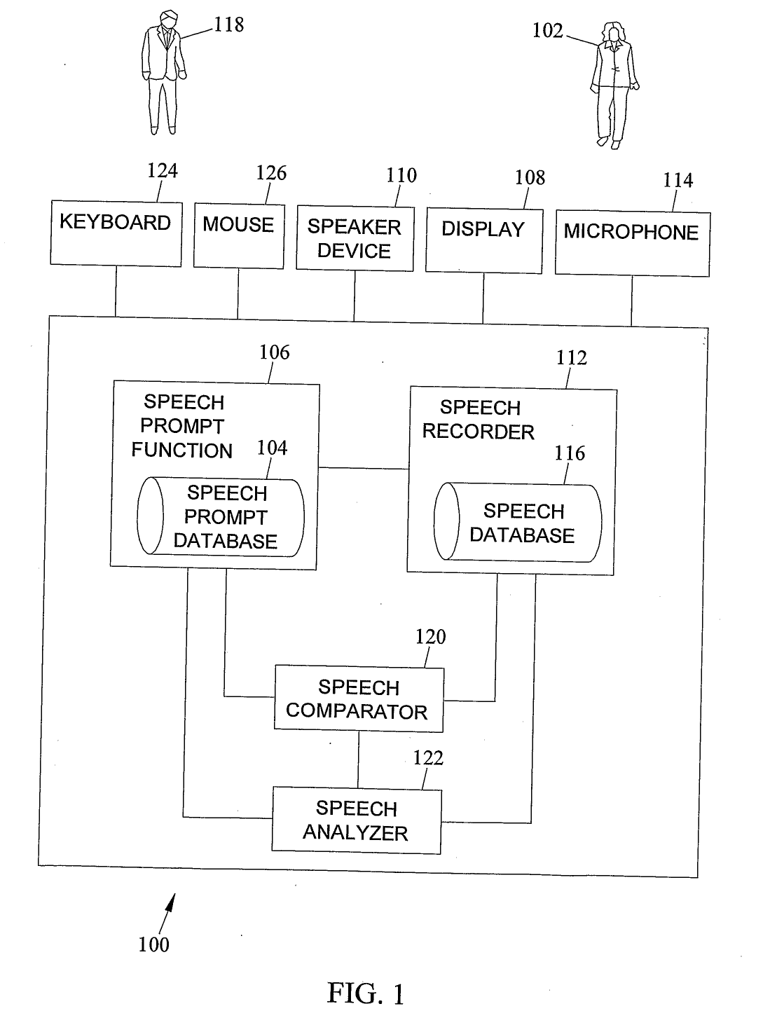

FIG. 1 illustrates a block diagram of a computer system 100 for speech assessment according to an embodiment of the subject matter described herein. Referring to FIG. 1, system 100 may include speech prompt functionality for prompting a speaker 102 to pronounce one or more words. The words that speaker 102 is prompted to pronounce may be target words for use in assessing particular speech productions difficulties. Speech prompt database 104 may store orthographic representations of target words for presentation to speaker 102. A word's orthographic representation can be a spelling of a word. An orthographic representation can be linked to a sound recording that is representative of the word, such as a recording of the word as spoken by a person with no speech production difficulties. The orthographic representation can also be linked to a graphical image that represents the word. Orthographic representations, graphical images, and sound recording of words can be stored in digital format in database 104. Words stored in database 104 can be organized into one or more lists for use in different speech assessment sessions for different speakers.

A speech prompt function 106 can select one or more words from database 104 for speaker 102 to pronounce. The words may be selected from a single speech assessment session list associated with speaker 102. Further, function 106 can prompt pronunciation of the selected words by presenting the stored orthographic representation, graphical image representation, and/or sound file of each word to speaker 102. The words may be presented to speaker 102 in an order sequence or randomly from the session list. An orthographic representation and a graphical image representation of a word can be presented to speaker 102 via a display 108. A phonetic, an orthographic, or another suitable representation of a word can be presented to speaker 102 via a speaker device 110.

In response to receiving word prompts from system 100, speaker 102 can provide a pronunciation of each word. System 100 is operable to record the speaker's word pronunciations. The word pronunciations can be recorded by a speech recorder module 112, a microphone 114, and a speech database 116. Microphone 114 is operable to receive the word pronunciations and convert the pronunciations to electrical representations of the pronunciations. Speech recorder module 112 can receive the electrical signal representations of the pronunciations and store the representations as one or more sound files in speech database 116. The recorded pronunciations can be optionally edited by an operator. For example, a sound file of a word pronunciation may be edited to remove unwanted background noise or to remove portions of the recording in which the speaker is not pronouncing the word. The recorded pronunciations can be individually selected and retrieved from database 116 for playback via speaker device 110.

System 100 can present recorded pronunciations to a listener 118 that can be a speech-language pathologist or clinician or a non-clinician. The recorded pronunciations can be played in sequence via speaker device 110. As each recorded pronunciation is presented, listener 118 can be prompted to enter a phonetic or orthographic representation of a word that the listener believes to be pronounced in the recorded pronunciation. For example, if a recorded pronunciation sounds like the word “tree” to listener 118, the listener can enter the word “tree” into system 100. The entered phonetic or orthographic representation of the word can be stored in system 100 by typing or any other suitable manner. Speech comparator 120 is operable to retrieve recorded pronunciations and play the pronunciations to listener 118 via speaker device 110. Further, speech comparator 120 can display a prompt to listener 118 for each played pronunciation via display 108. In each prompt, listener 118 can enter a phonetic or orthographic representation of a word that the listener believes to be pronounced in a played recording. The entered phonetic or orthographic representation can be a typed word or a word selected from a plurality of words displayed on display 108. Recorded pronunciations may be selectively played back to listener 118.

The phonetic or orthographic representation of the word entered by listener 118 can be compared to a representation of the actual word that speaker 102 was prompted to pronounce. System 100 can automatically compare the entered phonetic or orthographic representation of the word to a correct spelling of the word that speaker 102 was prompted to pronounce. For example, the phonetic or orthographic representation entered by listener 118 can be a spelling of the word that is either typed or selected from a plurality of words presented to the listener, and the entered word spelling can be compared to the correct spelling. Based on the comparison, speech comparator 120 can determine whether the entered phonetic or orthographic representation of each word matches a correct spelling of the actual word speaker 102 was prompted to pronounce. This comparison can provide data for determining mispronounced words. Based on the mispronunciations, the existence of a speech disorder can be determined. Further, the results of the comparison can be displayed via display 108. For example, display 108 can indicate for each word whether the entered phonetic or orthographic representation matches the correct spelling of the word that speaker 102 was prompted to pronounce.

In one embodiment, a multiple choice format can be used in which listener 118 enters the phonetic or orthographic representation of the word by selecting one word of a plurality of words presented via display 108. For example, recorded pronunciations can be played for listener 118. Listener 118 can be prompted to enter the phonetic or orthographic representation by selecting one of a multiple choice of words presented on display 108. Listener 118 can select one of the displayed words that the listener believes to be the actual word that speaker 102 was prompted to pronounce. The multiple choice of words can include the actual word that speaker 102 was prompted to pronounce for the recording. The other words in the multiple choice can be foil words that are similar in sound to the actual word that speaker 102 was prompted to pronounce. The selected target or foil word can be compared to the actual word presented to the speaker for use in assessing the speech of the speaker. The results of the comparison can be displayed via display 108. For example, display 108 can indicate for each word whether the selected word matches the correct spelling of the word that speaker 102 was prompted to pronounce.

System 100 can analyze the information entered by speaker 102 and listener 118 for assessing the speech of speaker 102. In one embodiment, system 100 can include a speech analyzer 122 that uses the comparison data for analyzing the speech of speaker 102. Speech analyzer 122 can compile the analysis data into a report and display the report via display 108 or any other suitable device for displaying data. Further, for example, speech analyzer 122 can generate a report of mean intelligibility for a particular speech sample and speaker across a group of listeners. The reports can be automatically generated at the end of a speech assessment session.

A system according to the subject matter described herein may be used to assess a variety of language and speech disorders. In one embodiment, the system described herein may be used for assessing apraxia of speech and aphasia. For example, system 100 may be configured for presenting a list of words for assessing apraxia of speech and aphasia in a speaker. One exemplary session list can include a group of monosyllabic words. The list can include several sets of phonetically similar words. For example, a list of 600 monosyllabic words can include 50 sets of 12 phonetically similar words. The words can cover a variety of phonetic contrasts for emphasizing distinctions known to be affected in apraxia of speech and in aphasia. In this example, the phonetic similarity within the subsets can be maximized by having each word form a minimal pair with at least one word in the set and at least three words forming a minimal pair with at least two other words in the set (e.g., pit, pet, peek, peel, bet, sit, beak, pick, heel, sick, seek, and bat). Each word may not appear in more than three subsets. Each word entered into system 100 can be linked to an orthographic representation of the word and a sound recording of the word spoken by a person with normal speech. In one embodiment, the sound recording may be a recording of the word being spoken by listener 118, and the orthographic representation may be word as typed by listener 118.

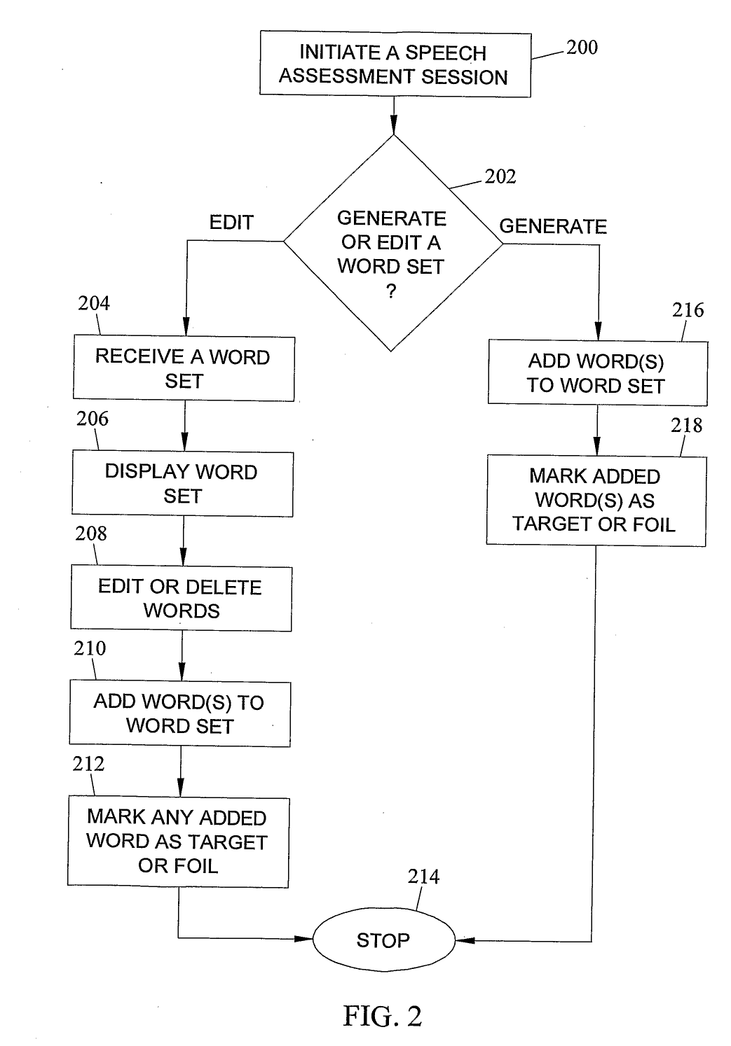

FIG. 2 is a flow chart illustrating an exemplary process for configuring system 100 shown in FIG. 1 for a speech assessment session according to an embodiment of the subject matter described herein. In this example, listener 118 may be a speech-language pathologist or clinician using system 100 to assess the speech of speaker 102. Referring to FIG. 2, in block 200, listener 118 can initiate a speech assessment session to enter a list or word set of target words or target utterances for assessing the speech of speaker 102. For each word in the set, an orthographic representation of the word and a sound recording of the spoken word can be stored in speech prompt database 104. After configuration, the orthographic representations and the sound recordings of the words in the set can be used in a speech assessment session for prompting speaker 102 to pronounce the words.

In block 202, a determination can be made as to whether or not to generate or edit a word set. In one embodiment, speech prompt function 106 can query listener 118 whether to generate a new word set or edit a word set previously stored in system 100. Display 108 can display the query to listener 118. In response to the query, listener 118 can use a keyboard 124 or a mouse 126 to select word set generation or editing. If a determination is made to edit a word set, a word set can be received or retrieved for editing from a database, such as speech prompt database 104 (block 204). The words in the received word set can be displayed via display 108 (block 206). Listener 118 can use keyboard 124 or mouse 126 to select one or more of the displayed words for editing or deletion (block 208). Listener 118 can select to play a sound recording of the word.

Listener 118 can selectively add words to the received word set (block 210). The added words may be entered by listener 118 or selected from other words stored in a database, such as database 104. If listener 118 adds a word by entering the word, listener 118 can enter an orthographic representation by typing the word via keyboard 124. Listener 118 can enter a sound recording of the word by speaking the word into microphone 114. The orthographic and sound recording of the word can be associated with the word set and stored in speech prompt database 104. In addition, listener 118 may add foil words for use in the multiple choice format for assessing speech. When a foil word is added, listener 118 may only be required to enter an orthographic representation of the word. Any added words can be marked as being a target word or a foil word (block 212). The process can stop at block 214.

Referring again to block 202, a new word set can be generated if a determination is made to generate a new word set. Listener 118 can add words to the new word set (block 216). Listener 118 can add words to the new word set by entering the words and selecting words stored in a database, such as speech prompt database 104. Listener 118 can enter an orthographic representation of the word by typing the word via keyboard 124 and a phonetic or orthographic representation by speaking the word into microphone 114. The orthographic and phonetic or orthographic representations of the word can be stored in the new word set in speech prompt database 104. The words may be marked as being a target word or a foil word (block 218). The process can stop at block 214.

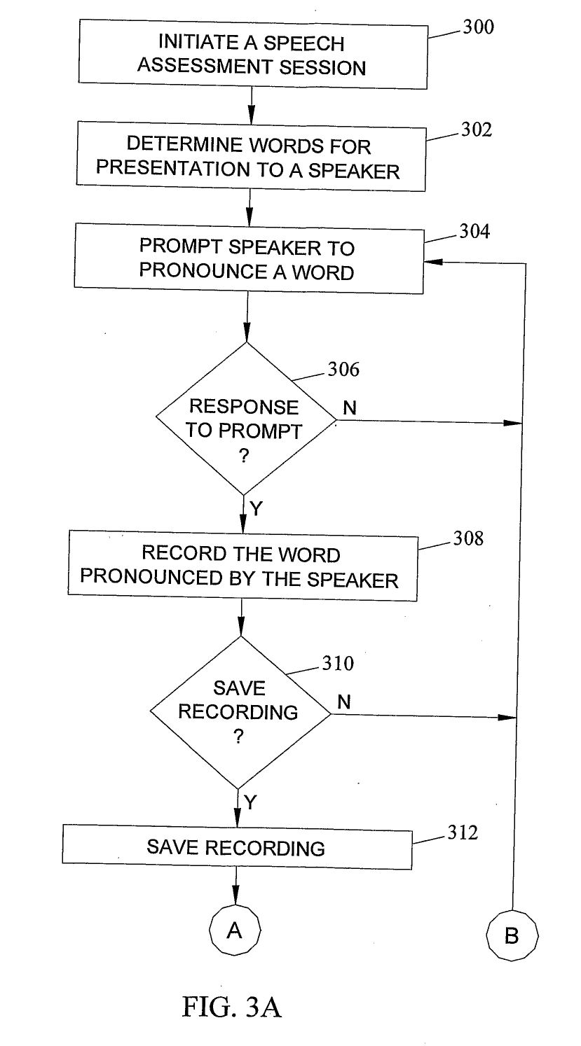

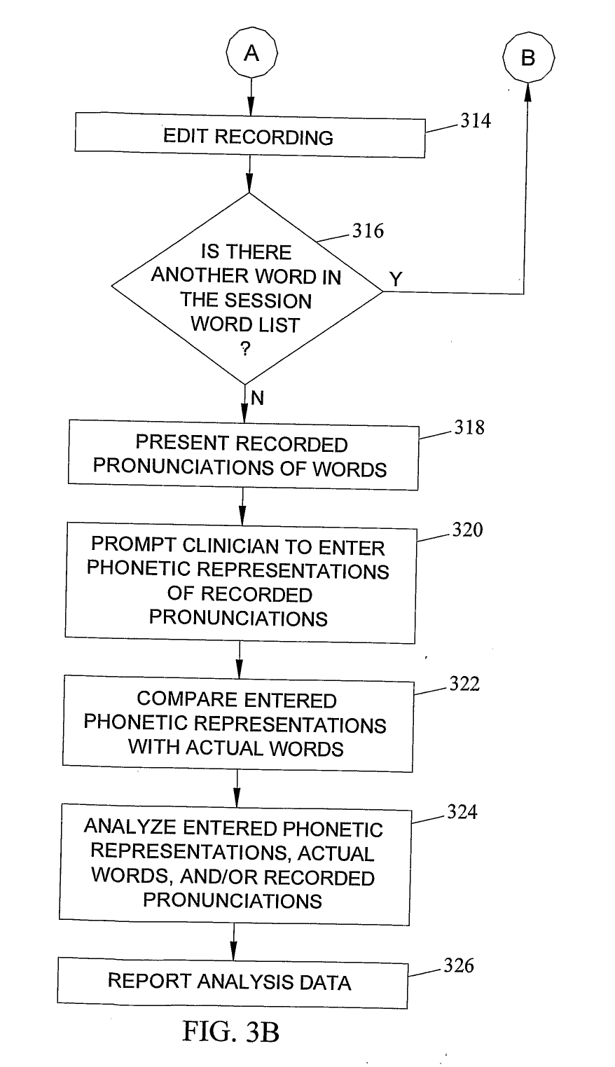

System 100 can prompt a speaker to pronounce the words of a word set and record the word pronunciations for speech assessment. FIGS. 3A and 3B are flow charts illustrating an exemplary process for assessing speech using system 100 shown in FIG. 1 according to an embodiment of the subject matter described herein. In this example, listener 118 may be a speech-language pathologist or clinician using system 100 to assess the speech of speaker 102. Referring to FIG. 3A, in block 300, listener 118 may initiate a speech assessment session. The initiation of a speech assessment session can include specifying session information such as information about speaker 102 and listener 118. For example, the speaker and listener information can include demographic information and information regarding previous sessions.

In block 302, target words for presentation to speaker 102 can be determined. In one embodiment, speech prompt function 104 can obtain the target words from one or more word sets stored in speech prompt database 104. The words can be randomly selected from one or more word sets. The determined words for the session can be placed in a session list of words. The session word list can be selected specifically for assessing any speech or language disorders for speaker 102.

In block 304, speaker 102 is prompted to pronounce one of the words in the session word list. Speech prompt function 104 can present the words to speaker 102 one-by-one via display 108 and/or speaker device 110. Prompting of speaker 102 can include presenting the orthographic representation of the word and/or a sound recording of a pronunciation of the word. For example, display 108 can display text of the word. Further, for example, the sound recording can be presented to speaker 102 by playing a recording of listener 118 or another person speaking the word normally. Listener 118 can selectively present the word representations to speaker 102 in the sequence of the word list or randomly from the word list. In an alternate embodiment, listener 118 can control the onset and offset of word presentation by using mouse 126. For example, listener 118 can present the word by pronouncing the word to speaker 102 and controlling the display of the orthographic representation of the word via display 108.

In response to the word presentation, speaker 102 can pronounce the presented word. System 100 can record the pronounced word. In block 306, speech recorder 112 can determine whether speaker 102 provides a word pronunciation response to the prompt. If speaker 102 does not respond with a word pronunciation, speaker 102 can be prompted again in block 204. If speaker responds, speech recorder 112 can record the word pronunciation (block 308). Recording can begin when speaker 102 begins the pronunciation and stopped when speaker 102 stops the pronunciation. In one embodiment, speaker 102 or listener 118 can control when the recording begins and ends. For example, the buttons of keyboard 122 or a mouse 126 can be used to start and stop recording. In an alternate embodiment, speech recorder 112 can detect speech and control when recording begins and ends. For example, recording can be stopped after a pause of at least one second after termination of sound from speaker 102.

Further, speaker 102 or listener 118 can be queried as to whether or not to save the recording of the pronunciation (block 310). In one embodiment, display 108 can play the recording and display a query as to whether or not to save the recording. Speaker 102 or listener 118 can use keyboard 122 or mouse 126 to indicate whether or not to save the recording. If it is indicated not to save the recording, speaker 102 can again be prompted to pronounce the word in block 204. Otherwise, the recording can be saved (block 212). In one embodiment, the recording of the word pronunciation can be stored as a sound file (e.g., a WAV sound file) in speech database 116. Each pronunciation can also be saved as a separate sound file.

In block 314 shown in FIG. 3B, the recorded pronunciation can be edited. In one embodiment, speaker 102 or listener 118 can edit the recorded pronunciation. For example, the recorded pronunciation can be played back via speaker device 110. Based on the playback, speaker 102 or listener 118 can edit the recorded pronunciation. In another example, display 108 can display a visual representation of the sound waves of the recorded pronunciation. Based on the visual representation, speaker 102 or listener 118 can edit the recorded pronunciation.

In block 316, speech prompt function 104 can determine whether there is a word in the session word list that has not been presented to speaker 102. If it is determined that there is another word in the session word list for presentation to speaker 102, the process can proceed to block 304 for prompting speaker 102 to pronounce the next word in the list. Otherwise, if it is determined that there is not another word in the list, the process can proceed to block 318.

Referring to block 318, the recorded pronunciations can be presented to listener 118 or another listener for assessing the speech of speaker 102. Speech comparator 120 can retrieve the recorded pronunciations of the words from speech database 116 and play the recorded pronunciations via speaker device 110. Further, speech comparator 120 can control display 108 to display prompts for listener 118 to enter a phonetic or orthographic representation of the one or more recorded pronunciations. The phonetic or orthographic representation can be a representation of a word that listener 118 believes to be pronounced in the recorded pronunciation.

In block 320, speech comparator 120 can prompt listener 118 to enter phonetic or orthographic representations of the recorded pronunciations. The prompting can include displaying one or more text fields for entering the phonetic or orthographic representations as a text spelling of the word. Listener 118 can use keyboard 122 and mouse 126 for entering the phonetic or orthographic representations.

Speech comparator 120 can automatically compare the entered phonetic or orthographic representations with the actual word (block 322). For example, if the phonetic or orthographic representation is entered as a text spelling, the entered text can be compared to the correct spelling of the word. Further, speech analyzer 124 can analyze the entered phonetic or orthographic representations, the actual word (e.g., a correct spelling of the word), and/or the recorded pronunciations (block 324) and report resulting analysis data to listener 118 (block 326). The data may be presented via display 108, speaker device 110, or any other suitable device for outputting data.

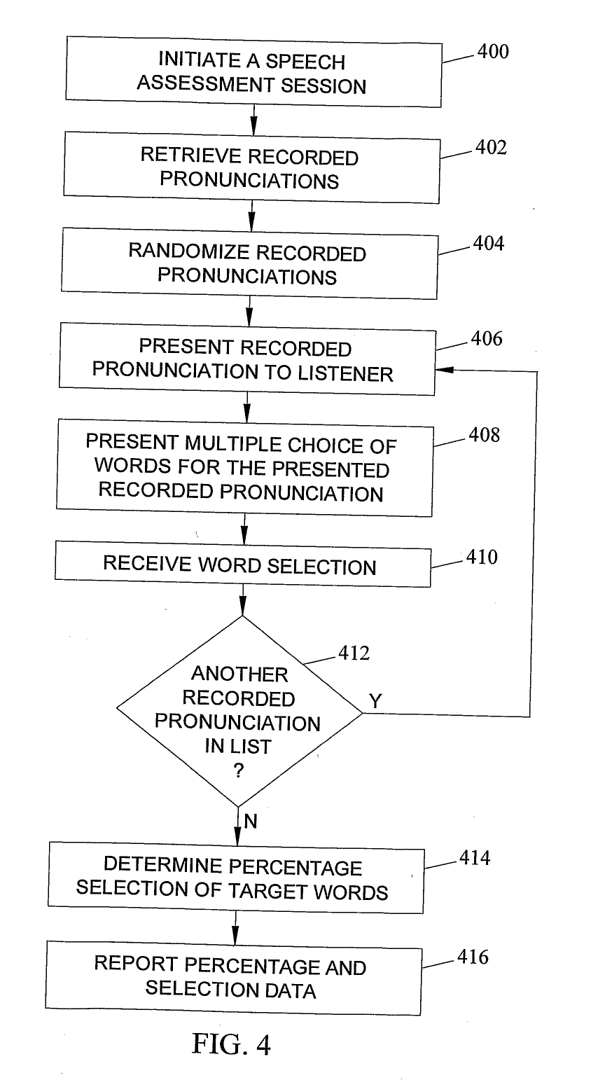

FIG. 4 is a flow chart illustrating another exemplary process for assessing speech using system 100 shown in FIG. 1 according to an embodiment of the subject matter described herein. This exemplary process is implemented using system 100 shown in FIG. 1. Referring to FIG. 4, in block 400, listener 118 can initiate a speech assessment session. The initiation of a speech assessment session can include specifying session information such as information about speaker 102 and listener 118. For example, the speaker and listener information can include demographic information and information regarding previous sessions. In block 402, a list of recorded pronunciations for the selected speaker can be retrieved (block 402) and the recorded pronunciations randomized (block 404).

In block 406, a recorded pronunciation from the list can be presented to listener 118. The recorded pronunciation can be presented to listener 118 with speaker device 110. Further, a set of words in a multiple choice format can be presented to listener 118 (block 404). The set of words can include at least one target word and at least one foil word. The target word can be a correct spelling of the word presented to the listener when the pronunciation was recorded. The foil words can be words that sound similar to the recorded pronunciation. To minimize listener learning effects, the order in which foil words appear can be randomized. The multiple choice set of words can be presented via display 108.

Listener 118 can use keyboard 122 or mouse 126 to select one of the words presented in the multiple choice set. Speech comparator 120 can receive and store the word selection (block 410). In block 412, a determination can be made as to whether there is another recorded pronunciation in the session list. If it is determined that there is another recorded pronunciation in the session list, the process can proceed to block 406 to present another recorded pronunciation to the listener. Otherwise, if it is determined that there is not another recorded pronunciation in the session list, the process can proceed to block 414.

Referring to block 414, the percentage of target words selected by the listener can be determined. Further, in block 416, the percentage of target words selected by the listener can be reported to the listener. Also, in block 416, the selection data can be reported to the listener. The selection data can include each of the multiple choice sets and the word for each set that was selected by the listener.

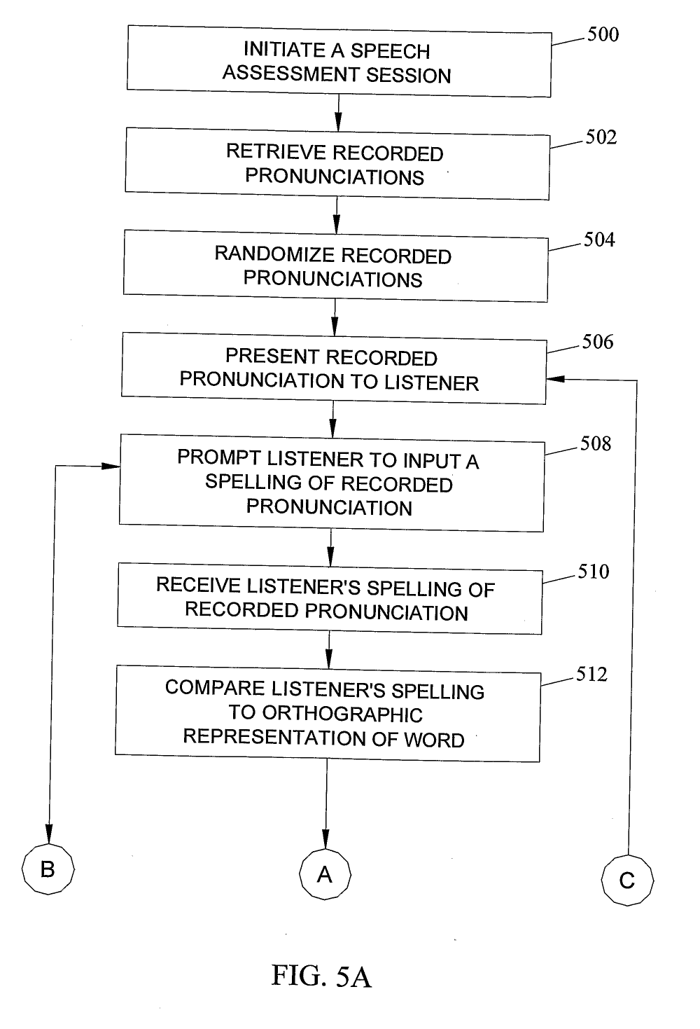

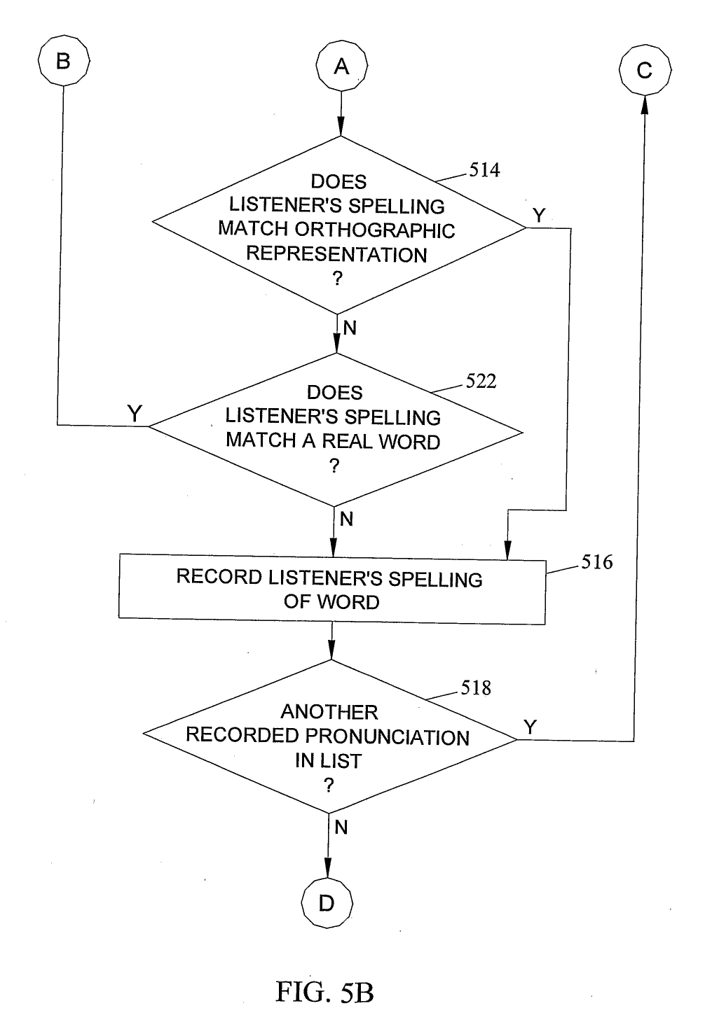

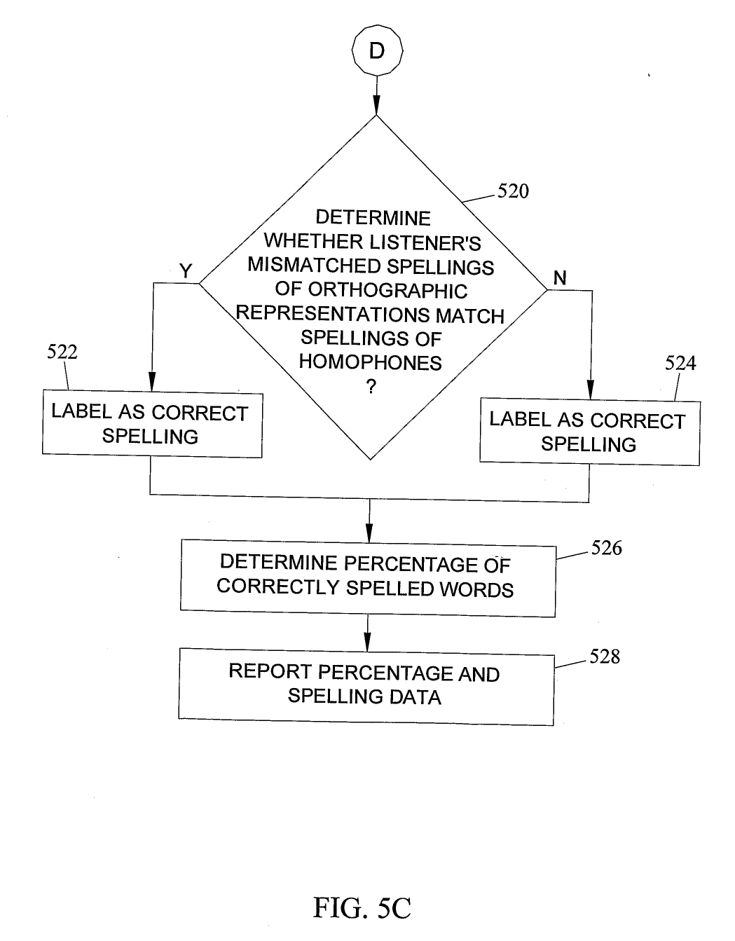

FIGS. 5A, 5B, and 5C are flow charts illustrating an exemplary process for assessing speech using an orthographic transcription format according to the subject matter described herein. This exemplary process can be implemented using system 100 shown in FIG. 1. Referring to FIG. 5A, in block 500, listener 118 can initiate a speech assessment session. The initiation of a speech assessment session can include specifying session information such as information about speaker 102 and listener 118.

Recorded pronunciations for the selected speaker can be retrieved (block 502) and the pronunciations randomized (block 504). For example, speech comparator 120 can retrieve a speaker's recorded pronunciations from speech database 118. Alternatively, for example, speaker 102 can pronounce words for recording by speech recorder 112.

In block 506, a recorded pronunciation in the list can be presented to listener 118. The recorded pronunciation can be presented to listener 118 with speaker device 110. Further, listener 118 can be prompted to input a spelling of the recorded pronunciation (block 508).

Listener 118 may use keyboard 122 to enter a spelling of the recorded pronunciation. Speech comparator 120 can receive the spelling of the word (block 510). Next, speech comparator 120 can compare an orthographic representation of the word with the listener's spelling of the word (block 512). In block 514 shown in FIG. 5B, a determination can be made as to whether the listener's spelling matches the orthographic representation of the word. If it is determined that the listener's spelling matches the orthographic representation of the word, the listener's spelling is recorded (block 516). In block 518, a determination can be made as to whether there is another recorded pronunciation in the list. If there is another recorded pronunciation in the list, the process can proceed to block 506 to present another recorded pronunciation to the listener. Otherwise, if it is determined that there is not another recorded pronunciation in the list, the process can proceed to block 520.

Referring again to block 514, if it is determined that the listener's spelling does not match the orthographic representation of the word, the process proceeds to block 522. In block 522, a determination can be made as to whether the listener's spelling matches the spelling of a real word. In one embodiment, a database with the correct spelling for a plurality of words can be searched for a matching word spelling. If no match is found, it can be determined that there is no matching word spelling. If it is determined that the listener's spelling does not match the spelling of a real word, the listener's spelling of the word can be recorded in block 516. Otherwise, if it is determined that the listener's spelling matches the spelling of a real word, the process can proceed to block 508 to prompt the listener to again input a spelling of the recorded pronunciation.

Referring to block 520 shown in FIG. 5C, a determination can be made as to whether the listener's mismatched spellings of orthographic representations match the spellings of homophones. If a listener's mismatched spelling matches the spelling of a homophone, the listener's spelling can be labeled as correct (block 522). Otherwise, the listener's spelling can be labeled as incorrect (block 524).

In block 526, the percentage of correctly spelled words can be determined. Further, in block 528, the percentage of correctly spelled words can be reported to the listener. Also, in block 528, the spelling data can be reported to the listener. The selection data can include each of the words spelled by the listener and the correct spelling of the word.

In one embodiment, if a word is provided by the listener that is not recognized as a real word, the listener can be prompted to try a different spelling. Further, following data collection and prior to analysis, the listener can optionally review all word pairs where there is a mismatch between the spellings. A prompt can be displayed for indicating whether each pair should be considered a match. Although the word pair is spelled differently, it can be considered a matched pair if the words are homophones of one another.

In one embodiment, the recorded pronunciations can be presented to a plurality of different listeners. The different listeners can each enter phonetic or orthographic representations of the recorded pronunciations. Further, the entered phonetic or orthographic representations can be automatically compared to correct spellings of the words. By obtaining phonetic or orthographic representations from a plurality of different listeners, it may be more likely that the comparison of the phonetic or orthographic representations to the correct spellings is more accurate.

In one embodiment, the subject matter described herein may be used for speech assessment in several different languages and dialects. For example, a word set in Spanish can be generated for a Spanish-speaking person. The Spanish words in the set can be presented to the Spanish speaker for word pronunciations according to the subject matter described herein.

In yet another embodiment, the subject matter described herein may be used to provide measurements and editing of the acoustics of recorded speaker pronunciations. For example, measurements of acoustic durations may be displayed to an operator of system 100 shown in FIG. 1. The acoustic measurements can be used for accommodating variations in a speaker population. Acoustic measurement reports can be provided by speech analyzer 122 shown in FIG. 1.

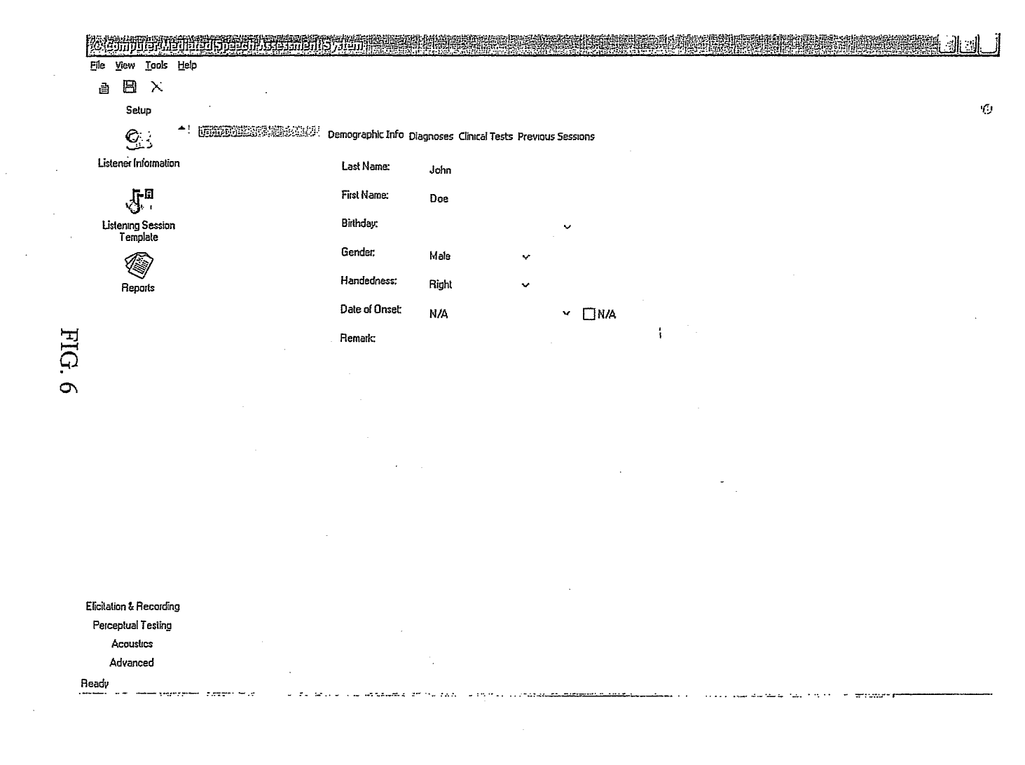

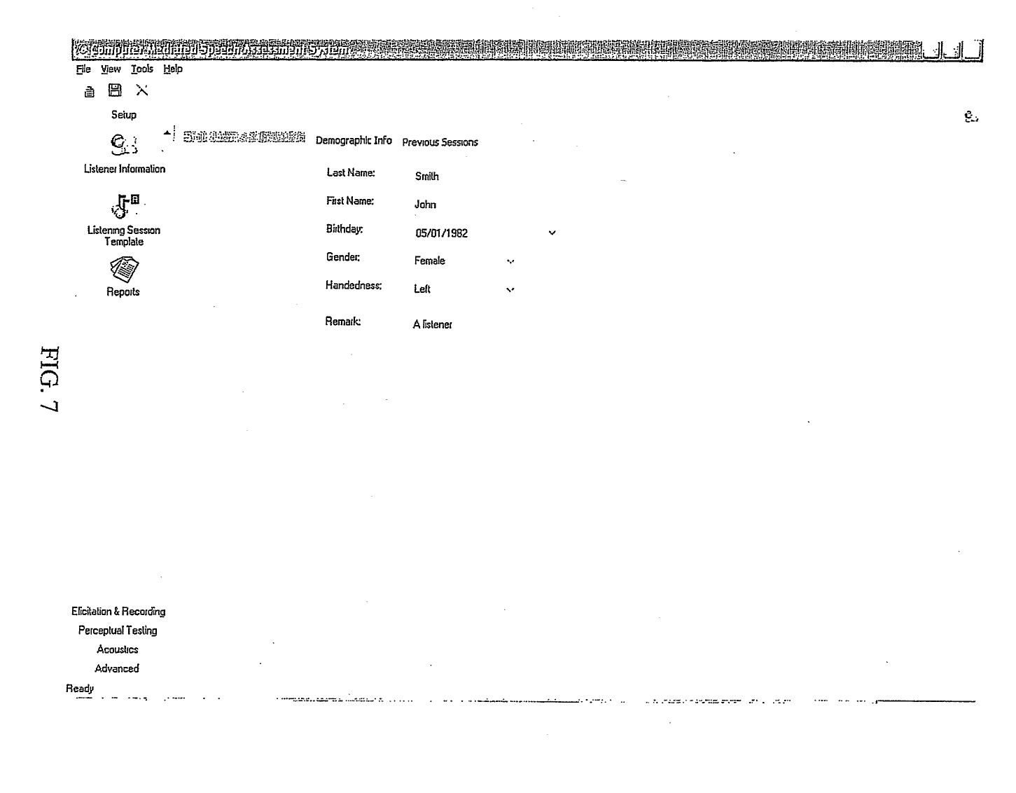

FIGS. 6 and 7 illustrate exemplary screen displays that can be displayed by system 100 shown in FIG. 1 for initiating a speech assessment session according to an embodiment of the subject matter described herein. The screen displays can be displayed by display 108 shown in FIG. 1. Referring to FIG. 6, the screen display can include fields with which speaker information can be entered. The speaker information that can be entered can include demographic information, diagnoses information, information about the speaker's clinical tests, and information about the speaker's previous speech assessment sessions. Referring to FIG. 7, the screen display can include fields for entering listener information such as demographic information and information about the listener's previous speech assessment sessions.

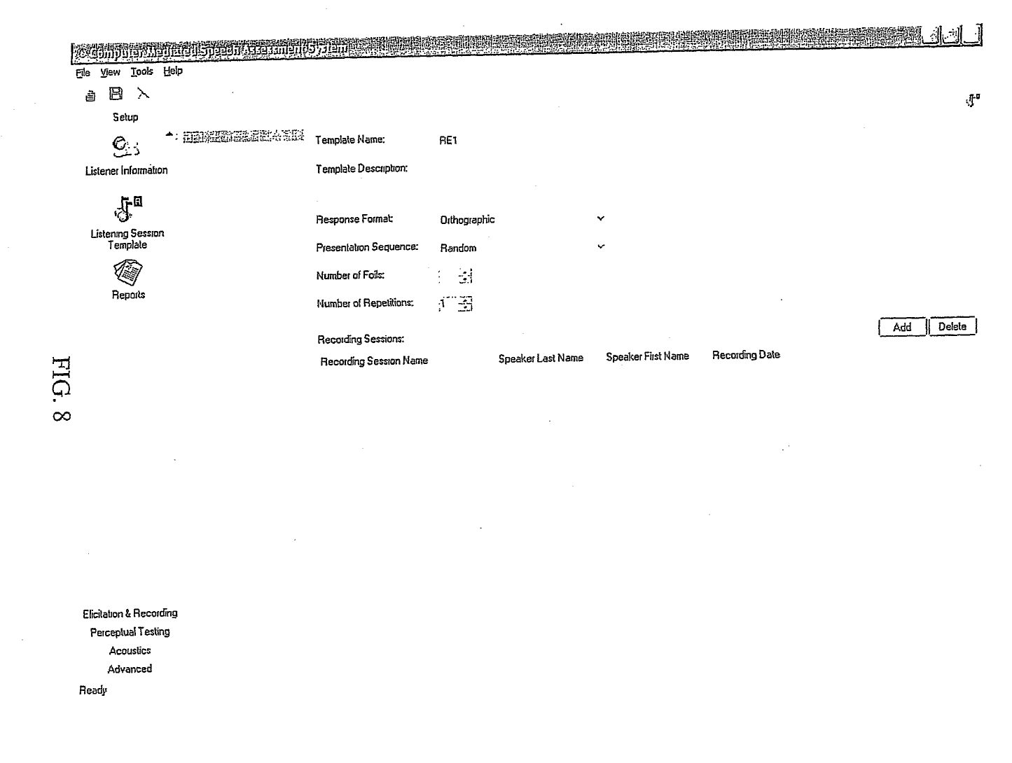

FIG. 8 illustrates an exemplary screen display that can be displayed by system 100 shown in FIG. 1 for configuring a session template according to one embodiment of the subject matter described herein. The screen displays can be displayed by display 108 shown in FIG. 1. Referring to FIG. 8, the screen display can include fields for entering a session template name and test description. Further, the screen display can include a field for specifying a perceptual test response format, such as orthographic or multiple choice. If the multiple choice format is specified, the user may also specify the number of foils used in each multiple choice. A presentation sequence field can be provided for specifying whether the words are presented randomly or in order. The number of foils for multiple choice testing can be specified. Further, the number of repetitions of each word may be specified.

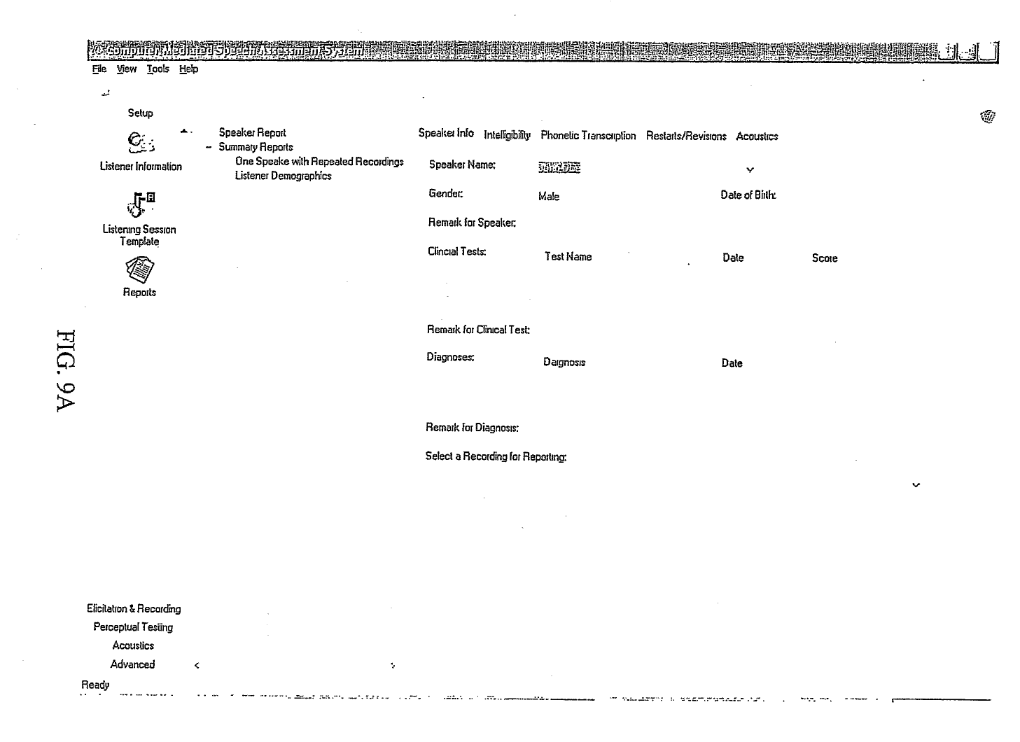

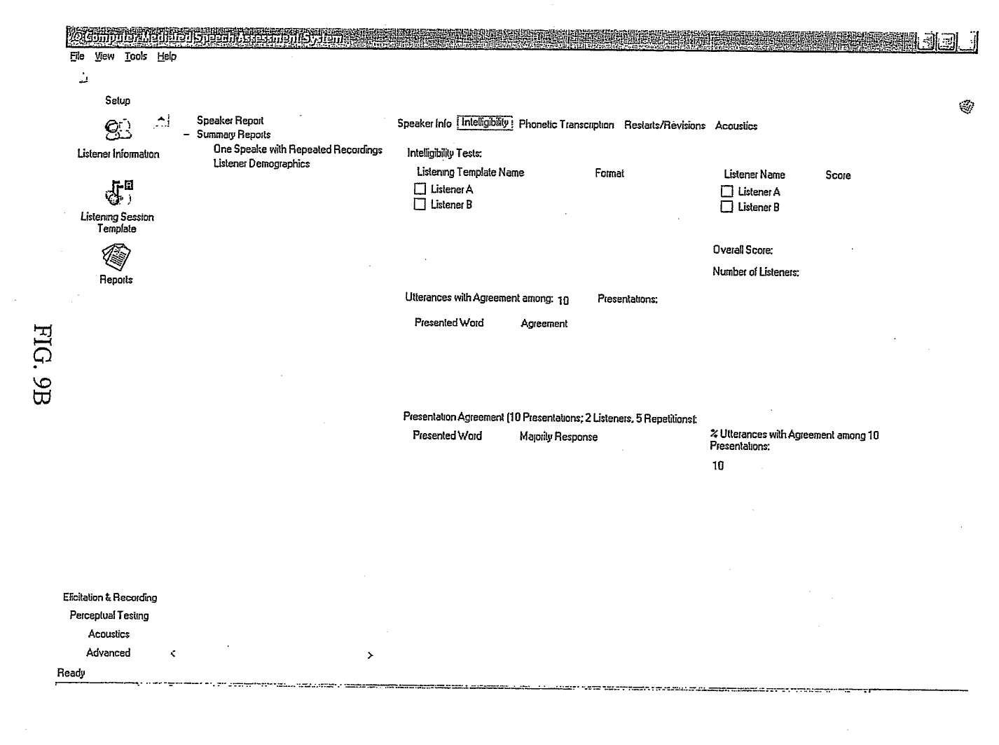

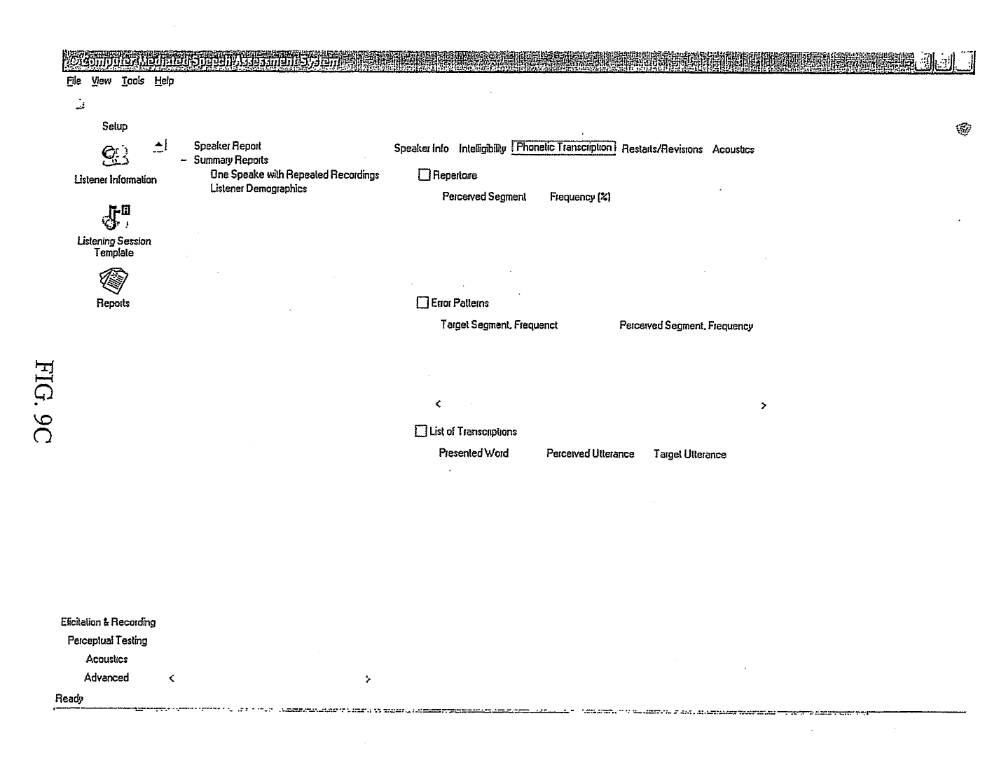

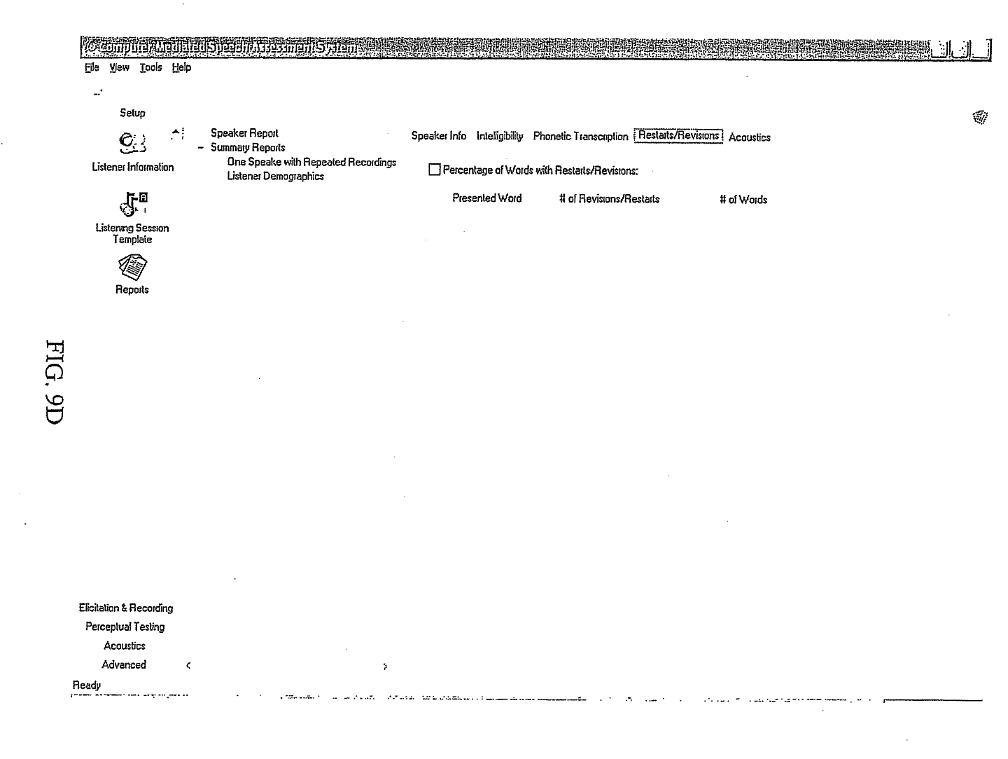

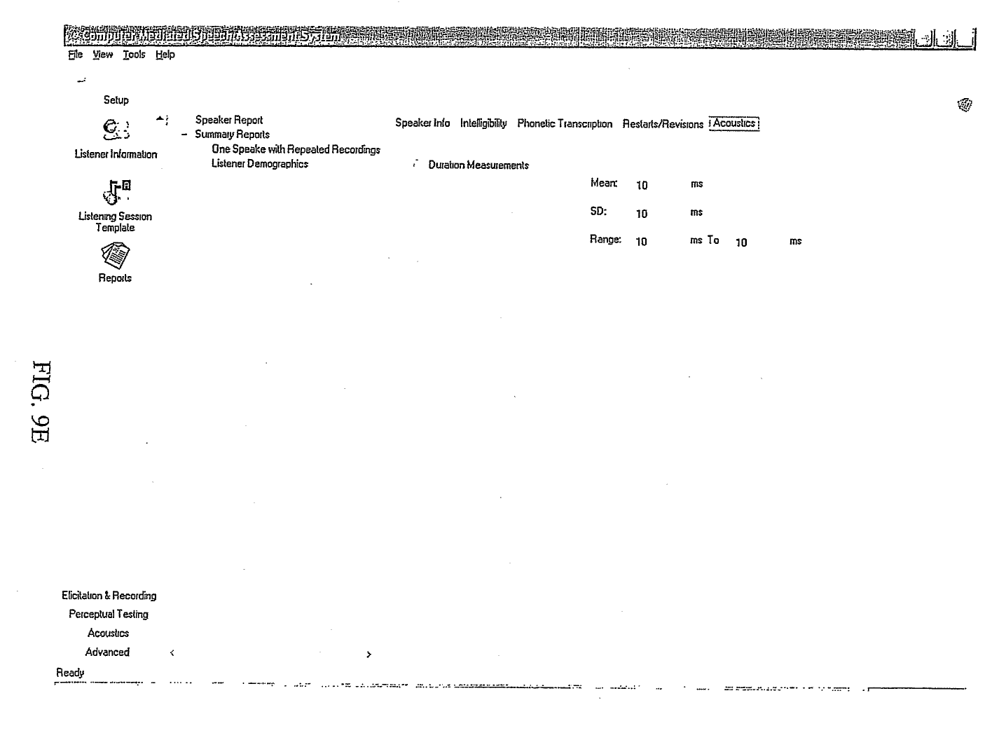

FIGS. 9A-9E illustrates exemplary screen displays that can be displayed by system 100 shown in FIG. 1 for configuring speech assessment reports according to an embodiment of the subject matter described herein. The screen displays can be displayed by display 108 shown in FIG. 1. These screen displays allow an operator to select session information and export the session information to a file. The screen displays can include summaries of a speaker or listener demographics, results of session tests that have been completed, and acoustic measures for a speaker. Referring to FIG. 9A, the screen display can include fields with which reports can be configured for a speaker. Referring to FIG. 9B, the screen display can include fields with which reports can be configured for one or more listeners associated with one speaker. Referring to FIG. 9C, the screen display can include session analysis information such as a list of words in a session, the perceived utterance for each word, and the target utterance for each word. Referring to FIG. 9D, the screen display can include words presented in a session, the number of revisions/restarts of the word, and the number of words. Referring to FIG. 9E, the screen display can display acoustic measures for words presented in a session, such as duration measurements including mean, standard deviation, and range.

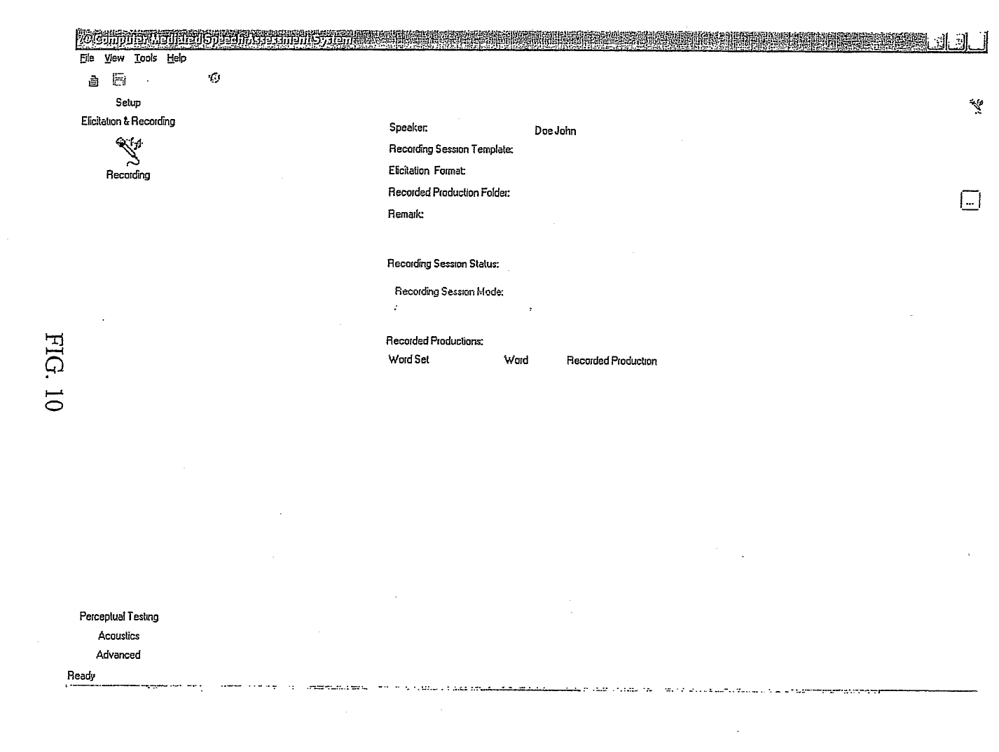

FIG. 10 illustrates an exemplary screen display that can be displayed by system 100 shown in FIG. 1 for providing recording information according to an embodiment of the subject matter described herein. The screen displays can be displayed by display 108 shown in FIG. 1. Referring to FIG. 10, the screen display can include recording information such as speaker identification information, the name of the recording session template, the elicitation format (e.g., word and graphical image representation), folder containing the recording, word set information, and whether there is a pause between each presented word. This screen display can be used to start a new recording or continue a previous recording.

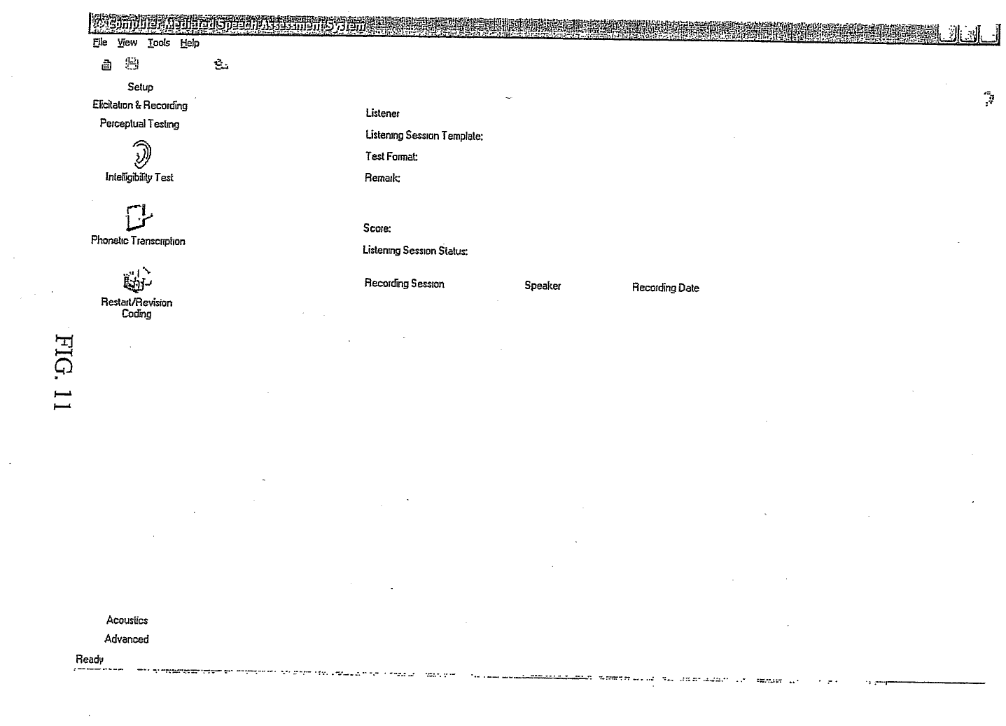

FIG. 11 illustrates an exemplary screen display that can be displayed by system 100 shown in FIG. 1 for providing intelligibility test information according to an embodiment of the subject matter described herein. The screen displays can be displayed by display 108 shown in FIG. 1. Referring to FIG. 11, the screen display can include information such as listener identification, the name of the listening session template, the test format (e.g., multiple choice format), and testing scores.

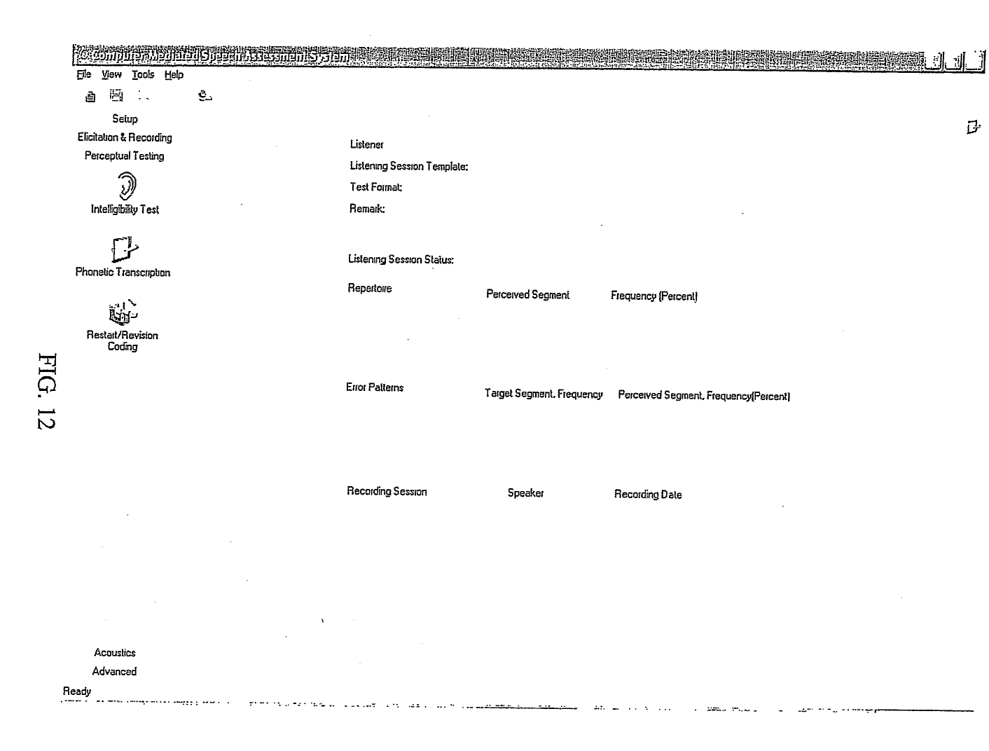

FIG. 12 illustrates an exemplary screen display that can be displayed by system 100 shown in FIG. 1 for phonetic transcription according to an embodiment of the subject matter described herein. The screen display can be displayed by display 108 shown in FIG. 1. Referring to FIG. 12, the screen display can include information regarding the status of a listening session (for example, whether the session is complete or incomplete) and regarding the frequency of different speech sounds and error patterns in the speech sample. In one embodiment, when a session is started, the screen display can display the recorded words and tables of vowel and consonant symbols that can be selected to represent the sound sequence that is perceived and/or the sound sequence that is expected in the presented target word.

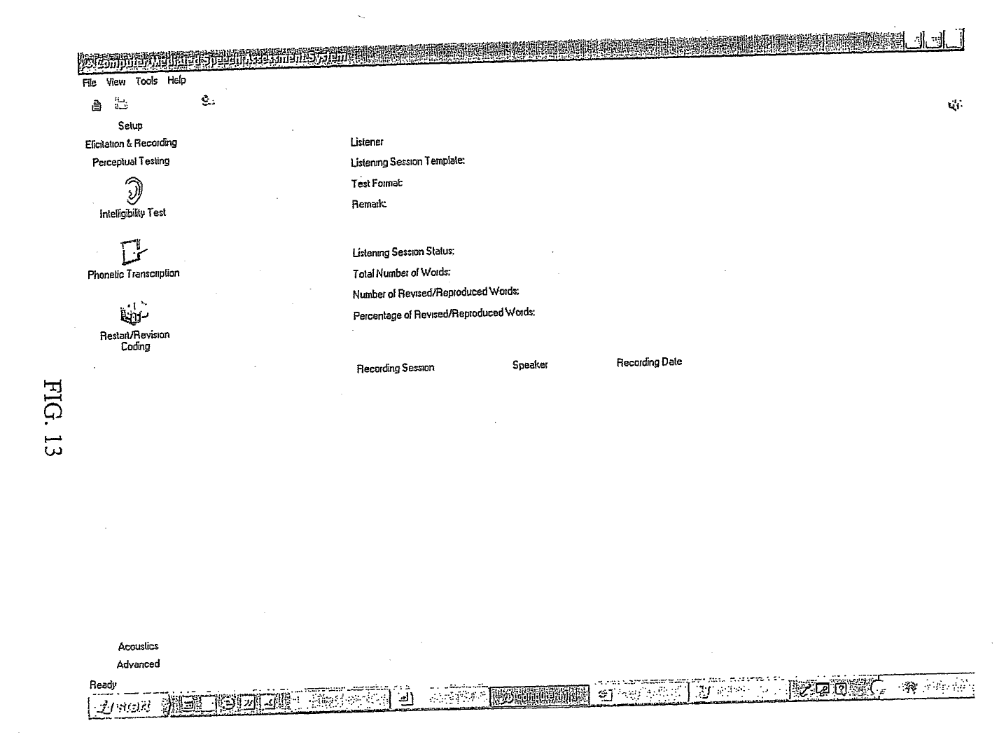

FIG. 13 illustrates an exemplary screen display that can be displayed by a computer system for restart and revision coding according to an embodiment of the subject matter described herein. The screen display can be displayed by display 108 shown in FIG. 1. Referring to FIG. 13, the screen display can display the status of a listening session (for example, whether the session is complete or incomplete) and regarding the frequency of restarts and revisions perceived. In one embodiment, when a session is started, the screen display can display the recorded productions of pronunciations, the number of words in each production, and the number of restarts/revisions in each production.

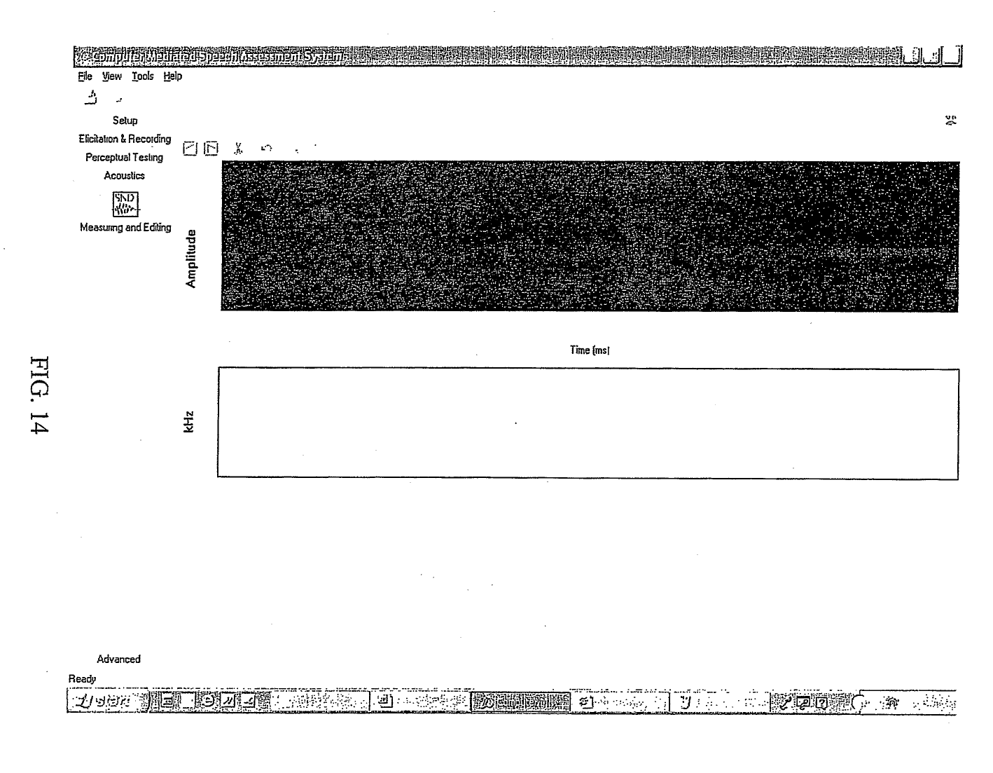

FIG. 14 illustrates an exemplary screen display that can be displayed by system 100 shown in FIG. 1 for measuring and editing a recorded pronunciation according to an embodiment of the subject matter described herein. The screen displays can be displayed by display 108 shown in FIG. 1. Referring to FIG. 14, a waveform and a spectrograph of a speech recording may be displayed. Further, an operator may interface with the icons and fields of the screen display to measure the duration of a speech or pronunciation sample, the duration of a syllable in the sample, the duration of a segment of the sample, and the duration between segments in the sample. In addition, the operator can edit the displayed recording to remove unwanted pauses in the recording or unintentional recordings. An edited recording can be automatically saved.

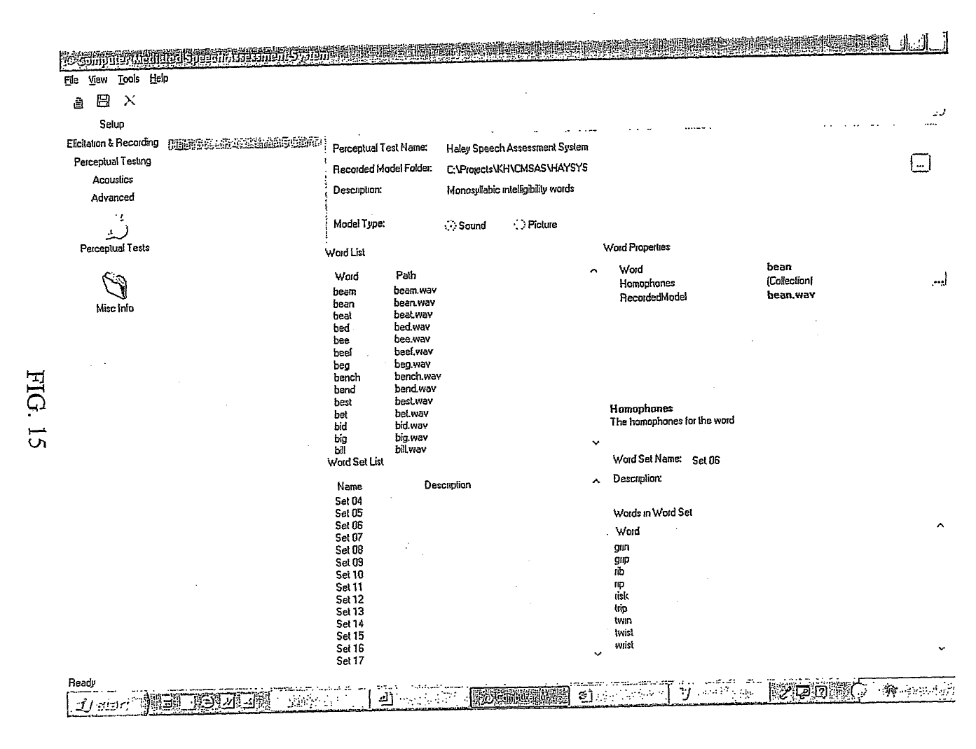

FIG. 15 illustrates an exemplary screen display that can be displayed by system 100 shown in FIG. 1 for displaying and configuring word list information according to an embodiment of the subject matter described herein. The screen displays can be displayed by display 108 shown in FIG. 1. Referring to FIG. 15, the screen display can display session tests that can be selected. The tests can include intelligibility tests, phonetic transcription tests, and restarts/revisions.

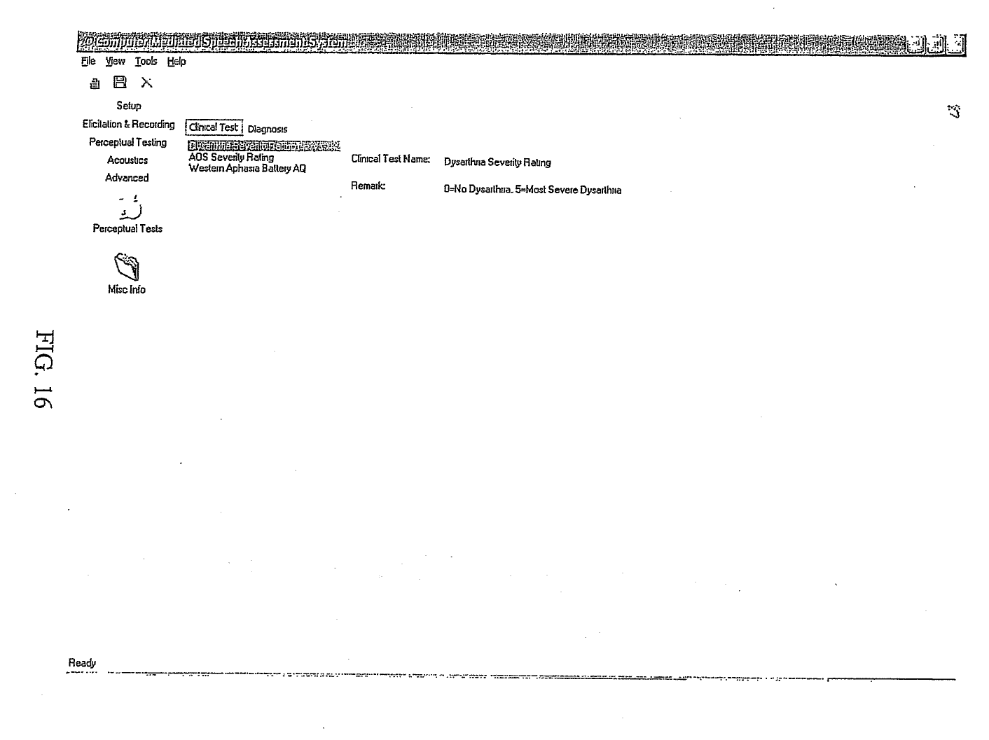

FIG. 16 illustrates an exemplary screen display that can be displayed by system 100 shown in FIG. 1 for displaying miscellaneous clinical test and diagnosis information according to an embodiment of the subject matter described herein. The screen display can be displayed by display 108 shown in FIG. 1. Referring to FIG. 16, the screen display can display clinical tests and diagnosis options that a clinician or listener can specify when entering information about a speaker. Further, the screen display can be used to create new selection options.

It will be understood that various details of the subject matter described herein may be changed without departing from the scope of the subject matter described herein. Furthermore, the foregoing description is for the purpose of illustration only, and not for the purpose of limitation.

What is claimed is:

1. A speech assessment method comprising:
(a) prompting a speaker to pronounce one or more words;
(b) recording the one or more words pronounced by the speaker to generate one or more recorded pronunciations;
(c) presenting the one or more recorded pronunciations to a listener;
(d) in response to presentation of the one or more recorded pronunciations, prompting the listener to enter a phonetic or orthographic representation of the one or more recorded pronunciations; and
(e) comparing the entered phonetic or orthographic representation with a correct spelling of the one or more words.

2. The speech assessment method of claim 1 wherein prompting a speaker to pronounce one or more words comprises displaying orthographic representations of the one or more words on a display.

3. The speech assessment method of claim 1 or 2 wherein prompting a speaker to pronounce one or more words comprises displaying a graphical image representation of the one or more words on a display.

4. The speech assessment method of claim 1 wherein recording the one or more words comprises storing the one or more recorded pronunciations in one or more sound files.

5. The speech assessment method of claim 1 wherein presenting the one or more recorded pronunciations to a listener comprises playing the one or more recorded pronunciations with a speaker device.

6. The speech assessment method of claim 1 wherein prompting the listener to enter a phonetic or orthographic representation of the one or more recorded pronunciations comprises prompting the listener to enter an orthographic representation of the one or more recorded pronunciations.

7. The speech assessment method of claim 1 wherein prompting the listener to enter a phonetic or orthographic representation of the one or more recorded pronunciations comprises:
(a) displaying a plurality of orthographic representations of words, wherein at least one of the displayed orthographic representations corresponds to one of the words that the speaker is prompted to pronounce; and
(b) prompting the listener to select one of the displayed orthographic representations that the listener believes to correspond to one of the pronounced words.

8. The speech assessment method of claim 1 comprising automatically comparing the phonetic or orthographic representation entered with a correct spelling of the one or more words and comprising comparing a spelling of the entered phonetic or orthographic representation with a correct spelling of the one or more words.

9. The speech assessment method of claim 8 further comprising indicating whether the spelling of the entered phonetic or orthographic representation matches the correct spelling of the one or more words.

10. The speech assessment method of claim 1 wherein the one or more recorded pronunciations are presented to a plurality of different listeners and wherein the listeners each enter phonetic or orthographic representations of the one or more recorded pronunciations, and wherein each entered phonetic or orthographic representation is automatically compared to a correct spelling of the one or more words.

11. The speech assessment method of claim 1 further comprising optionally editing at least a portion of the one or more recorded pronunciations prior to presentation of the one or more recorded pronunciations to the listener.

12. The speech assessment method of claim 1 further comprising:
(a) generating a word list including the one or more words in a database; and
(b) associating the one or more words with orthographic representations of the one or more words, graphical image representations of the one or more words, and/or recordings of a normal pronunciation of the one or more words.

13. The speech assessment method of claim 12 wherein prompting a speaker to pronounce one or more words comprises displaying the orthographic representations of the one or more words on a display.

14. The speech assessment method of claim 12 wherein prompting a speaker to pronounce one or more words comprises displaying the graphical image representations of the one or more words on a display.

15. The speech assessment method of claim 12 wherein prompting a speaker to pronounce one or more words comprises playing the recordings of a normal pronunciation of the one or more words.

16. A speech assessment method comprising:
(a) determining target utterances for presentation to a speaker from a set of target utterances stored in a database;
(b) prompting the speaker to pronounce the target utterances;
(c) recording the target utterances pronounced by the speaker to generate recorded pronunciations of the target utterances;
(d) optionally editing at least a portion of the recorded pronunciations of the target utterances;
(e) presenting the recorded pronunciations of the target utterances to a listener;
(f) in response to presentation of the recorded pronunciations, prompting the listener to enter phonetic or orthographic representations of the recorded pronunciations of the target utterances; and
(g) comparing the phonetic or orthographic representations entered with correct spellings of the target utterances.

17. A speech assessment system comprising:
(a) a speech prompt function operable to prompt a speaker to pronounce one or more words;
(b) a speech recorder operable to record the one or more words pronounced by the speaker to generate one or more recorded pronunciations, and operable to present the one or more recorded pronunciations to a listener; and
(c) a speech comparator for prompting the listener to enter a phonetic or orthographic representation of the one or more recorded pronunciations, and for automatically comparing the entered phonetic or orthographic representation with a correct spelling of the one or more words.

18. The speech assessment system of claim 17 wherein the speech prompt function is operable to display orthographic representations of the one or more words on a display.

19. The speech assessment system of claim 17 or 18 wherein the speech prompt function is operable to display a graphical image representation of the one or more words on a display.

20. The speech assessment system of claim 17 comprising a speech database for storing the one or more record pronunciations in one or more sound files.

21. The speech assessment system of claim 17 comprising a speaker device for playing the one or more recorded pronunciations with a speaker device.

22. The speech assessment system of claim 17 wherein the speech comparator is operable to prompt the listener to enter an orthographic representation of the one or more recorded pronunciations.

23. The speech assessment system of claim 17 comprising a display for displaying a plurality of orthographic representations of words, wherein at least one of the displayed orthographic representations corresponds to one of the words that the speaker is prompted to pronounce, and wherein the speech prompt function is operable to prompt the listener to select one of the displayed orthographic representations that the listener believes to correspond to one of the pronounced words.

24. The speech assessment system of claim 17 wherein the speech comparator is operable to compare a spelling of the entered phonetic or orthographic representation with a correct spelling of the one or more words.

25. The speech assessment system of claim 24 comprising a display for indicating whether the spelling of the entered phonetic or orthographic representation matches the correct spelling of the one or more words.

26. The speech assessment system of claim 17 wherein the speech prompt function is operable to present the one or more recorded pronunciations to a plurality of different listeners and wherein the listeners each enter phonetic or orthographic representations of the one or more recorded pronunciations, and wherein the speech comparator is operable to automatically compare each entered phonetic or orthographic representation to a correct spelling of the one or more words.

27. The speech assessment system of claim 17 wherein the speech recorder is operable to edit at least a portion of the one or more recorded pronunciations prior to presentation of the one or more recorded pronunciations to the listener.

28. The speech assessment system of claim 17 further comprising a database including a word list having the one or more words, wherein the one or more words are associated with orthographic representations of the one or more words, graphical image representations of the one or more words, and/or recordings of a normal pronunciation of the one or more words.

29. The speech assessment system of claim 28 comprising a display for displaying the orthographic representations of the one or more words.

30. The speech assessment system of claim 28 comprising a display for displaying the graphical image representations of the one or more words.

31. The speech assessment system of claim 28 comprising a speaker device for playing the recordings of a normal pronunciation of the one or more words.

32. A computer program product comprising computer executable instructions embodied in a computer readable medium for performing steps comprising:
(a) prompting a speaker to pronounce one or more words;
(b) recording the one or more words pronounced by the speaker to generate one or more recorded pronunciations;
(c) presenting the one or more recorded pronunciations to a listener;
(d) in response to presentation of the one or more recorded pronunciations, prompting the listener to enter a phonetic or orthographic representation of the one or more recorded pronunciations; and
(e) comparing the entered phonetic or orthographic representation with a correct spelling of the one or more words.

33. The computer program product of claim 32 wherein prompting a speaker to pronounce one or more words comprises displaying orthographic representations of the one or more words on a display.

34. The computer program product of claim 32 or 33 wherein prompting a speaker to pronounce one or more words comprises displaying a graphical image representation of the one or more words on a display.

35. The computer program product of claim 32 wherein recording the one or more words comprises storing the one or more record pronunciations in one or more sound files.

36. The computer program product of claim 32 wherein presenting the one or more recorded pronunciations to a listener comprises playing the one or more recorded pronunciations with a speaker device.

37. The computer program product of claim 32 wherein prompting the listener to enter a phonetic or orthographic representation of the one or more recorded pronunciations comprises prompting the listener to enter an orthographic representation of the one or more recorded pronunciations.

38. The computer program product of claim 32 wherein prompting the listener to enter a phonetic or orthographic representation of the one or more recorded pronunciations comprises:
(a) displaying a plurality of orthographic representations of words, wherein at least one of the displayed orthographic representations corresponds to one of the words that the speaker is prompted to pronounce; and
(b) prompting the listener to select one of the displayed orthographic representations that the listener believes to correspond to one of the pronounced words.

39. The computer program product of claim 32 comprising automatically comparing the phonetic or orthographic representation entered with a correct spelling of the one or more words and comprising comparing a spelling of the entered phonetic or orthographic representation with a correct spelling of the one or more words.

40. The computer program product of claim 39 further comprising indicating whether the spelling of the entered phonetic or orthographic representation matches the correct spelling of the one or more words.

41. The computer program product of claim 32 wherein the one or more recorded pronunciations are presented to a plurality of different listeners and wherein the listeners each enter phonetic or orthographic representations of the one or more recorded pronunciations, and wherein each entered phonetic or orthographic representation is automatically compared to a correct spelling of the one or more words.

42. The computer program product of claim 32 further comprising optionally editing at least a portion of the one or more recorded pronunciations prior to presentation of the one or more recorded pronunciations to the listener.

43. The computer program product of claim 32 further comprising:
(a) generating a word list including the one or more words in a database; and
(b) associating the one or more words with orthographic representations of the one or more words, graphical image representations of the one or more words, and/or recordings of a normal pronunciation of the one or more words.

44. The computer program product of claim 43 wherein prompting a speaker to pronounce one or more words comprises displaying the orthographic representations of the one or more words on a display.

45. The computer program product of claim 43 wherein prompting a speaker to pronounce one or more words comprises displaying the graphical image representations of the one or more words on a display.

46. The computer program product of claim 43 wherein prompting a speaker to pronounce one or more words comprises playing the recordings of a normal pronunciation of the one or more words.
